(19) United States
(12) Patent Application Publication
(10) Pub. No.: US 2026/0252705 A1
(43) Pub. Date: Aug. 27, 2026

(54) INTEGRATED VULNERABILITY FIX AND REDEPLOY SYSTEM

(71) Applicant: Honeywell International Inc., Charlotte, NC (US)

(72) Inventors: Komal Singh, Bangalore (IN); Venkata Naga Rameish Gadamsetty, Bangalore (IN); Subhan Dudekula, Bangalore (IN)

(21) Appl. No.: 19/062,054

(22) Filed: Feb. 25, 2025

(51) Int. Cl. G06F 21/57

(52) U.S. Cl. CPC G06F 21/577; G06F 21/572

(57) ABSTRACT

The present disclosure provides a method for securing containerized applications during application development and deployment process. The method comprises, obtaining vulnerability data associated with a plurality of container images, wherein the vulnerability data identifies a vulnerable version of a software package and an alternate version of the software package. The method further comprises, analysing, by an artificial intelligence engine, the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base. The method further comprises, recommending, by the artificial intelligence engine, a suggested version of the software package for each container image. The method further comprises, upgrading the vulnerable version of the software package based on comparison of the alternate version of the software package and the suggested version of the software package, wherein upgrading the vulnerable version of the software package comprises fixing one or more components of the software package to generate an updated container image. The method further comprises deploying the updated container image. A system for securing containerized applications is also disclosed.

### TECHNICAL FIELD

Embodiments of the present disclosure generally relate to vulnerability management of container-based applications in software development. Particularly, the present disclosure relates to a method and system for securing containerized applications during application development and deployment process.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Business enterprises today are increasingly implementing software development and operations (DevOps) platforms to enhance operational efficiency in the production and delivery of software products. The integration and collaboration of development and operations processes in a DevOps ecosystem enables business enterprises to quickly deliver high quality products and services with improved efficiency, stability and reliability. As customers'needs keep evolving, the business enterprises typically scale up their operations to meet their diverse requirements. Therefore, securing the application development and deployment environment becomes very important in a dynamic DevOps landscape.

Typically, software containers or containers are used in DevOps platforms for quick and efficient application deployment. A container is a portable standard unit of software that packages code and its dependencies in order for the applications to run quickly and reliably across multiple computing environments. A container image is a lightweight, standalone, executable package of software that includes everything required to run an application code, runtime, system tools, system libraries and settings. Container images often harbor security vulnerabilities that pose significant risks in the software development and deployment pipeline. Therefore, in a dynamic DevOps platform which generally has extensive deployments involving multiple containers, maintaining container security is crucial to ensure the integrity of deployed applications and data.

Security vulnerabilities may exist in containerized applications due to various reasons. For example, security vulnerabilities may be as a result of outdated software packages, misconfigurations, unpatched vulnerabilities, malware attacks among others. The historic and current manual processes on vulnerability detection and security fixes are prone to errors. It is estimated that business entities spend an average 30% of their time in managing security vulnerabilities. Therefore, automation of vulnerability checks, software version upgrades, patching and integration of security procedures into development and operations not only saves time, human efforts and resources, but also helps in maintaining consistent protection of the container pipeline. As per market surveys, automation of container security reduces time by up to 90%, leading to significant operational efficiencies and faster deployment cycles. Ensuring timely patching and deployment of secure container images eliminates manual errors, enhancing overall security posture.

Accordingly, there is a need for technical solutions to address the technical problems discussed above, and other inefficiencies of the prior arts. Particularly, there is a need to automate the process of securing containerized applications in DevOps platforms in order to ensure that the deployed applications remain consistently secure and stable. Thereby, enterprises can achieve an efficient framework for securing containerized applications, which enables quick application deployment and improved performance of the business environment.

The legacy approaches fail to provide efficient and robust techniques for vulnerability management for containerized applications. The present disclosure aims to provide a method and system for managing container image vulnerabilities and enables secure, efficient, and timely application deployments.

Applicant has identified many technical challenges and difficulties associated with current solutions and through applied effort, ingenuity, and innovation, the applicant has provided a solution to the above-mentioned drawbacks.

### SUMMARY OF THE INVENTION

In general, embodiments of the present disclosure relate to providing efficient techniques for vulnerability management for container applications in a business environment. Other implementations will be, or will become, apparent to one with skill in the art upon examination of the following figures and detailed description. It is intended that all such additional implementations be included within this description be within the scope of the disclosure and be protected within the scope of the following claims.

The present disclosure provides techniques for vulnerability management of container-based applications in development and delivery of software products. Specifically, the present disclosure provides a method and system for securing containerized applications by managing container image vulnerabilities. To this end, the present disclosure provides an Integrated Vulnerability Fix and Redeploy System (IVFRS) for automating the detection of container image vulnerabilities in software package, patching one or more components of the software package and redeploying the updated container image, thereby significantly reducing the time and effort required to maintain secure container images. The IVFRS leverages advanced Artificial Intelligence (AI) algorithms and a comprehensive automation framework to provide a robust solution for managing container image vulnerabilities.

In one embodiment, the present disclosure provides a method for securing containerized applications. The method comprises obtaining vulnerability data associated with a plurality of container images, wherein the vulnerability data identifies a vulnerable version of a software package and an alternate version of the software package. The method further comprises analyzing, by an artificial intelligence engine, the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base. The method further comprises recommending, by the artificial intelligence engine, a suggested version of the software package for each container image. The method further comprises upgrading the vulnerable version of the software package based on comparison of the alternate version of the software package and the suggested version of the software package, wherein upgrading the vulnerable version of the software package comprises fixing one or more components of the software package to generate an updated container image and deploying the updated container image.

In another embodiment, the present disclosure provides a system for securing containerized applications, the system comprising, a processor and a memory storing program instructions which, when executed by the processor, causes the processor to obtain vulnerability data associated with a plurality of container images, wherein the vulnerability data identifies a vulnerable version of a software package and an alternate version of the software package. The processor is further configured to analyze the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base. The processor is further configured to recommend a suggested version of the software package for each container image. The processor is further configured to upgrade the vulnerable version of the software package based on comparison of the alternate version of the software package and the suggested version of the software package, wherein the processor is configured to upgrade the vulnerable version of the software package by fixing one or more components of the software package to generate an updated container image. The processor is further configured to deploy the updated container image.

In yet another embodiment, the present disclosure provides a non-transitory computer-readable storage medium, storing program instructions executed by a processor to secure containerized applications. The program instructions when executed by the processor, obtains vulnerability data associated with a plurality of container images, wherein the vulnerability data identifies a vulnerable version of a software package and an alternate version of the software package. The program instructions when executed by the processor, analyzes the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base. The program instructions when executed by the processor, recommends a suggested version of the software package for each container image. The program instructions when executed by the processor upgrades the vulnerable version of the software package based on comparison of the alternate version of the software package and the suggested version of the software package, wherein upgrading the vulnerable version of the software package comprises fixing one or more components of the software package to generate an updated container image. The program instructions when executed by the processor deploys the updated container image.

The above summary is provided merely for the purpose of summarizing some example embodiments to provide a basic understanding of some aspects of the present disclosure. Accordingly, it will be appreciated that the above-described embodiments are merely examples and should not be construed to narrow the scope or spirit of the present disclosure in any way. It will be appreciated that the scope of the present disclosure encompasses many potential embodiments in addition to those here summarized, some of which will be further described below. Other features, aspects, and advantages of the subject will become apparent from the description, the drawings, and the claims.

### BRIEF DESCRIPTION OF THE DRAWINGS

Having thus described the embodiments of the disclosure in general terms, reference now will be made to the accompanying drawings, which are not necessarily drawn to scale, and wherein:

FIG. 1 illustrates an exemplary block diagram of an environment in which embodiments of the present disclosure may operate;

FIG. 2 illustrates an exemplary block of a system for securing containerized applications, in accordance with one or more embodiments described herein;

FIG. 3 is an exemplary block diagram illustrating implementation of a system for securing containerized applications (of FIG. 2) using AI engine in accordance with one or more embodiments described herein;

FIG. 4 illustrates another exemplary block diagram of a system for securing containerized applications, in accordance with one or more embodiments described herein;

FIG. 5 is an exemplary vulnerability report generated before vulnerability remediation in accordance with one or more embodiments described herein;

FIG. 6 is an exemplary vulnerability report generated after vulnerability remediation by the system of FIGS. 1-4, in accordance with one or more embodiments described herein;

FIGS. 7A and 7B illustrate a flow diagram of a method for securing containerized applications, in accordance with one or more embodiments described herein; and

FIG. 8 illustrates a general block diagram of a computing system that may be used by the method and system, in accordance with one or more embodiments described herein.

### DETAILED DESCRIPTION

Some embodiments of the present disclosure now will be described more fully hereinafter with reference to the accompanying drawings, in which some, but not all, embodiments of the disclosure are shown. Indeed, embodiments of the disclosure may be embodied in many different forms and should not be construed as limited to the embodiments set forth herein, rather, these embodiments are provided so that this disclosure will satisfy applicable legal requirements. Like numbers refer to like elements throughout.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” “in some embodiments,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

Software development and operations (DevOps) platforms are commonly adopted by business enterprises to enable improved operational efficiency in the development and production of software products. Particularly, when multiple software containers are used for application deployment in a dynamic DevOps landscape, securing containerized applications is paramount. Container images often harbor vulnerabilities that pose significant risks in the software development and deployment pipeline. Current market solutions predominantly focus on vulnerability detection and providing remediation suggestions, yet they fall short of automating the comprehensive process of remediating and redeploying container images. This gap necessitates manual intervention, which is both time-consuming and error-prone, leading to delays in addressing critical vulnerabilities and thereby escalating the risk of security breaches. Also, the absence of an end-to-end automated solution for container image vulnerability management results in operational inefficiencies and increased exposure to potential exploits. This deficiency is particularly problematic for organizations that rely on rapid and secure application deployment, as it necessitates substantial manual effort to maintain a secure environment.

Vulnerability management for a computing environment that uses containers is a resource intensive operation. Particularly, in case of large deployments which use multiple containers, scanning container images having multiple layers of software components is a challenging task. For instance, managing security fixes for a software product with over ten components typically requires nearly two days per component for manual validation and deployment. Therefore, the time, resources and human efforts required for managing security fixes increases in magnitude when tens and hundreds of such software products are released for multiple tenants. The process is not only time-consuming and error-prone but also delays the resolution of critical vulnerabilities, thereby increasing the risk of security breaches. Moreover, the constant influx of new vulnerabilities reported by customers and clients demands immediate attention resulting in deprioritizing other essential tasks and potentially impacting the customer relationships and overall productivity.

This challenge of managing container image vulnerabilities is not limited to a single sector, it is widespread and impacts various industries, including finance, healthcare, technology, and more. As the adoption of containerized applications in various sectors continues to grow, so does the demand for robust security solutions. For example, it is estimated that current manual processes of vulnerability detection and remediation are prone to errors and account for about 95% of security incidents. Further, there have been scenarios where security breaches are linked to vulnerabilities for which patches are available but not applied, leading to delay in patching and application deployment.

Therefore, if vulnerability management is automated, it eliminates manual errors, and enhances overall security posture. Also, automated patching techniques help in quickly addressing security vulnerabilities, significantly reducing the risk of breaches. In addition, an integrated system is required that can be deployed in diverse environments, whether on-premises or a cloud platform. Unlike current tools that focus solely on vulnerability detection or suggestions, there is a need to provide a comprehensive approach that seamlessly integrates with current vulnerability scanners and enhances their functionality with automated remediation.

Integrating automation and security into development and operations significantly reduces the operational costs and risks associated with manual patching processes. Organizations can save time and resources and ensure timely remediation of vulnerabilities. By ensuring timely patching and deployment of secure container images, the likelihood of security breaches can be reduced, potentially saving organizations and enterprises millions of dollars.

Thus, the lack of an automated end-to-end solution for managing container image vulnerabilities creates significant challenges in maintaining secure, efficient, and timely application deployments, thereby underscoring the need for a more robust and automated approach to vulnerability management.

Accordingly, there is a need to provide an efficient system and framework for an integrated vulnerability fix and redeployment that streamlines the patching and deployment process with intelligent AI/ML modules.

There is also a need to provide an efficient system for automated vulnerability management in dynamic work environments to enable reliability and accuracy of data, quick resolution of security issues, reduced operational costs and risks, continuous protection and stability for containerized applications and improved operational efficiency and overall health of the enterprises.

Accordingly, the present disclosure provides a method and system for securing a containerized environment by automating the process of fixing the security vulnerabilities found in the container images and seamlessly redeploying the container images into a production environment.

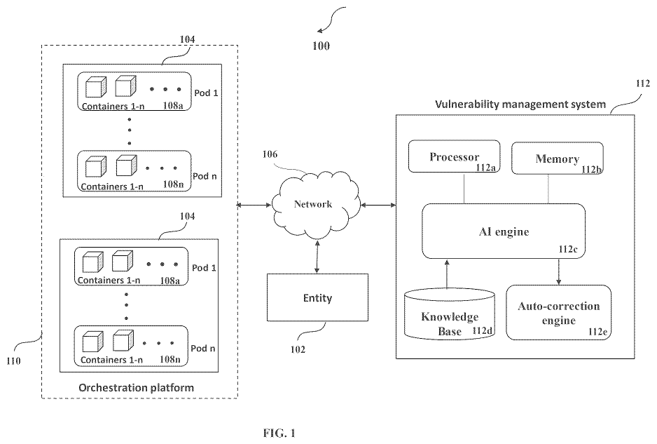

FIG. 1 illustrates an exemplary block diagram of an environment 100 or system, in which the embodiments of the present disclosure may operate. Specifically, FIG. 1 includes an entity 102 which may be a business entity or enterprise that manages container image vulnerabilities for securing container-based applications in application development and deployment. In an embodiment, the environment 100 includes a network 106, a vulnerability management system 112, an orchestration platform 110.

In an embodiment, the system 100 of FIG. 1 may be utilized by a business enterprise or entity 102 to manage vulnerabilities associated with container images in a containerized application environment. In a non-limiting example, enterprises may be involved in the manufacturing, distribution, sale of one or more products spanning across various industries, including finance, healthcare, technology, among others. In some embodiments, the vulnerability management system 112 of FIG. 1 may be configured to interface with an orchestration platform 110 that builds containerized applications and services.

According to various embodiments, the network 106 may be configured to provide communication between various components depicted in FIG. 1. In some embodiments, the network 106 may include a public network (e.g., the Internet), (e.g., an internal localized, or closed-off network between particular devices). In some other embodiments, the network 102 may be a hybrid network (e.g., a network enabling internal communications between particular connected devices and external communications with other devices). Such configuration(s) include, without limitation, a wired or wireless Personal Area Network (PAN), a Cloud network, Local Area Network (LAN), Metropolitan Area Network (MAN), Wide Area Network (WAN), and/or the like. In various embodiments, the network 106 may include one or more base station(s), relay(s), router(s), switch(es), routing station(s), and/or the like.

In an embodiment, the orchestration platform 110 manages the scaling up and deployment of multiple containers. For example, enterprises 102 may utilize container orchestration platform 110 such as OpenShift® and Kubernetes® to deploy, manage, and scale their applications. Kubernetes®, for example is an open-source orchestration platform that runs containers organized into nodes and pods. The orchestration platform 110, also called container platform may organize the containerized applications into one or more pods 104. Each pod 104 may comprise one or more containers 108a-108n. Each pod 104 is a deployable object in the network and a group or one or more pods 104 run on a cluster (not shown). Each container 108a-108n is a standard unit of software that packages the application code and its dependencies, and allows to run applications across multiple machines and environments including virtual, physical, cloud-based and on-premise. Containerization platforms like Docker™ enable users to develop, deploy, and run applications inside containers. Docker containers comprise container images constructed using multiple layers of software components. For example, a container image or docker image may include all the code and dependencies of an application (e.g. operating system, libraries, etc.) that allows the container to run quickly and reliably across multiple computing environments.

In an embodiment, the vulnerability management system 112 illustrated in FIG. 1 is configured to manage the vulnerabilities associated with container images or docker images. The vulnerability management system 112 may comprises a processor 112a communicably coupled to a memory 112b and an Artificial Intelligence (AI) engine 112c. The AI engine 112c leverages advanced AI algorithms to implement the functions of the vulnerability management system 112. In an embodiment, the AI engine 112c analyzes the container images for vulnerability in real-time based on historical data stored in a knowledge base 112d. In an embodiment, the AI engine 112c is configured to scan and analyze the vulnerability data based on historical data and recommend or suggest correct versions of the software package to fix the vulnerability. For example, a container image may have an outdated or vulnerable version of the operating system (OS) package which makes the container image not secure for deployment. In an embodiment, an auto-correction engine 112e of the vulnerability management system 112 is configured to automatically patch the vulnerable version of the software package to the suggested version recommended by the AI engine 112d. In an embodiment, the auto-correction engine 112e is configured to upgrade the vulnerable version of the operating system (OS) package as per the recommendation given by the AI engine 112d.

In an embodiment, the processor 112a may store and execute instructions for implementing the functions of the vulnerability management system 112. The memory 112b may be non-transitory and may include, for example, one or more volatile and/or non-volatile memories. In some embodiments, the memory 112b includes or embodies an electronic storage device (e.g., a computer readable storage medium). In some embodiments, the memory 112b is configured to store information, data, content, applications, instructions, or the like, for enabling a system to carry out various operations and/or functions in accordance with example embodiments of the present disclosure.

In one or more embodiments, the system 100 may include one or more software modules or components for managing security vulnerabilities associated with container images in dynamic DevOps environments in accordance with the one or more embodiments of the present disclosure. In an embodiment, the one or more software modules may include but not limited to AI engine 112c, auto-correction engine 112e which implement the functions of the vulnerability management system 112 through the processor 112a.

In an embodiment, one or more modules/engine of the system 100 may be implemented using electronic hardware, computer software, or any combination thereof. Whether such elements are implemented as hardware or software depends upon the application and design constraints imposed on the overall system. Examples of the systems may include computing systems (e.g., servers, datacenters, desktop computers, Internet of Things devices, etc.) and mobile computing systems (e.g., laptops, cell phones, etc.). Although components are described with respect to functional limitations, it should be understood that the particular implementations necessarily include the use of particular computing hardware. It should also be understood that in some embodiments certain of the components described herein include similar or common hardware.

Embodiments of the present disclosure may provide for vulnerability detection, remediation and redeployment process for a multi-tenant cloud-based system. Embodiments of the present disclosure may monitor and manage vulnerabilities associated with container images both in the cloud and on-premise. Embodiments of the present disclosure may integrate with third-party applications, new and existing applications and identities. Embodiments of the present disclosure may be scalable.

In one preferred embodiment, the environment 100 of the present disclosure may be configured as a cloud-based system. The environment 100 may include one or more servers and may provide different types of cloud computing services including but not limited to one or more services provided under Software as a Service (SaaS) category, services provided under Function-as-a-Service (FaaS) category, enterprise application container platforms, serverless computing platforms, microservices platforms, and cloud-based native application platforms, as well as other general cloud computing or enterprise computing infrastructures. In some embodiments, the cloud infrastructure is operated solely for an organization called the private cloud. In some embodiments, the cloud infrastructure is shared by several organizations called the community cloud. In some other embodiments, the cloud infrastructure is made available to the general public or a large industry group and is owned by an organization selling cloud services, called the public cloud. In some embodiments, the cloud infrastructure is a composition of two or more clouds (private, community, or public) that remain unique entities but are bound together by standardized or proprietary technology that enables data and application portability.

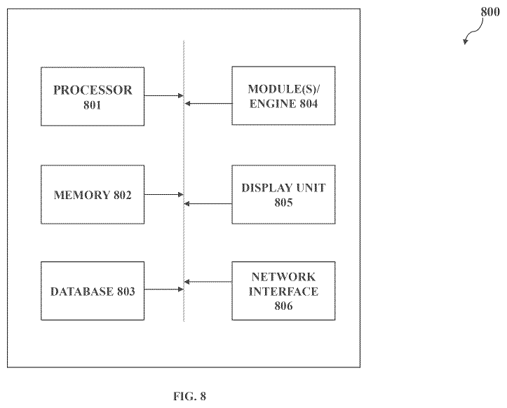

In some embodiments, the components of the environment 100 may include any suitable combination of hardware, firmware and software. For example, the components of the environment 100 may use one or more elements of the computer system of FIG. 8. It is to be appreciated that the particular arrangements of system 100 as illustrated in FIG. 1 are presented by way of illustrative example only, and numerous other arrangements are possible.

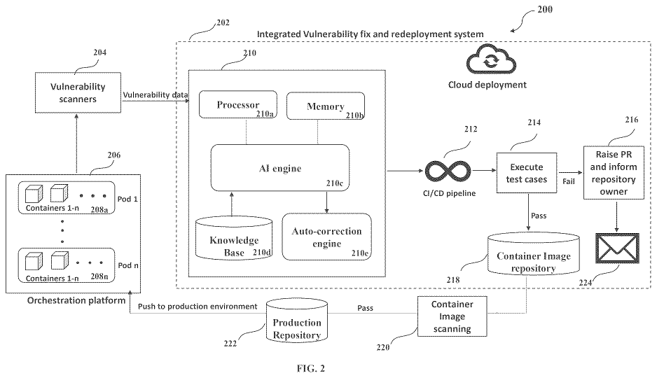

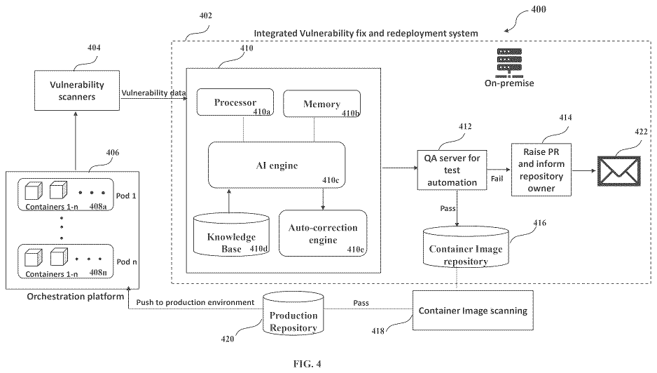

The vulnerability management system 112 of FIG. 1, in one or more embodiments is an integrated vulnerability fix and redeployment system (IVFRS) 202, in accordance with the embodiments of the present disclosure which is described in greater detail in FIGS. 2, 4.

FIG. 2 is an exemplary block diagram illustrating a system 200 for securing containerized applications in accordance with one or more embodiments described herein. In an embodiment, the system 200 for securing containerized applications may be an Integrated Vulnerability Fix and Redeployment System (IVFRS), 202 and may be implemented in a cloud-based system.

The system 200 may be operable by a business entity 102 (FIG. 1) to fix vulnerabilities in container images. In some embodiments, one or more business entities 102 may be involved in manufacturing, production, distribution, sales of one or products, and the products may range across various industries including but not limited to finance, healthcare, technology, among others, etc.

Typically, containerized applications are used in computing environments to streamline business operations. Containerization helps businesses to scale up or down their operations according to client demands and requirements and accordingly ensuring optimized resource utilization. When large number of such containerized applications are deployed in a dynamic DevOps platform, security vulnerabilities are inevitable. Vulnerabilities may exist in container images as a result of outdated libraries, dependencies or OS versions, unpatched vulnerabilities, malware attacks among others. Current manual process of detecting vulnerabilities in container images, patching and redeployment is cumbersome as it involves considerable human effort and resources. Also, manual process is error-prone and time consuming, thereby delaying the application deployment and compromising the performance of the system. Therefore, if security fixes are integrated into the development and deployment process, it ensures quick and faster deployment of applications in software development pipeline thereby improving the overall health of the system and the business operations.

Therefore, there is a need for automating the detection of container image vulnerabilities in software package, patching one or more components of the software package and redeploying the updated container image into production, thereby significantly reducing the time and effort required to maintain secure container images. The IVFRS leverages advanced Artificial Intelligence (AI) algorithms and a comprehensive automation framework to provide a robust solution for managing container image vulnerabilities. The system allows the development, operations and security teams to maintain high deployment frequencies and fast lead times without compromising security and minimizing false positives. The system aims to provide robust support for both on-premises and SaaS customers, offering tailored solutions for each environment. The system's ability to operate in both online and offline modes enhances its versatility, making it suitable for diverse deployment scenarios.

To this end, according to an embodiment, the IVFRS 202 is configured to dynamically analyze security vulnerabilities in a plurality of container images or docker images. Containerization platforms like Docker™ enable users to develop, deploy, and run applications inside containers. Also, the container applications are orchestrated through a platform like Kubernetes®. Kubernetes®, for example is an open-source orchestration platform that runs containers organized into nodes and pods. The orchestration platform may organize the containerized applications into one or more pods 206. Each pod 206 may comprise one or more containers 208-208n. Each pod 206 is a deployable object in the network and a group or one or more pods 206 run on a cluster (not shown).

In some embodiments, IVFRS comprises an AI engine 210c which is operatively coupled to a processor 210a and memory 210b. The processor 210a may store and execute instructions for implementing the functions of the IVFRS 202. The AI engine 210c leverages advanced AI algorithms to implement the functions of the IVFRS 202. In an embodiment, the IVFRS is configured to obtain vulnerability data associated with a plurality of container images, wherein the vulnerability data identifies a vulnerable version of a software package and an alternate version of the software package. For example, a container image may have an outdated or vulnerable version of the software package (i.e. operating system (OS) package) which makes the container image and the container not secure for deployment. In an embodiment, the IVFRS 202 integrates with known vulnerability scanners 204 to obtain vulnerability data identifying the vulnerable versions and the patch or alternate versions of the OS package for a plurality of container images. Examples of some known vulnerability scanners may be Trivy, Clair, and Anchore, Twistlock etc. In an embodiment, the IVFRS fetches the vulnerability data from vulnerability scanner 204 using REST (Representational State Transfer) APIs. The vulnerability data fetched by the vulnerability scanner 204 identifies the vulnerable version of the OS package and the alternate version, which may be the available fix version for the OS package. In an embodiment, the vulnerability data may be a vulnerability analysis report generated by scanning the container images. The report may include vulnerability details such as the severity of the security vulnerability for each container image, name of the container image, name of the container, organization ID, the name of the OS package, the vulnerable version of the OS package, the alternate version of the OS package which is the available fix or patch for the vulnerable version, the CVE (common vulnerabilities exposure) score, CVSS score among others.

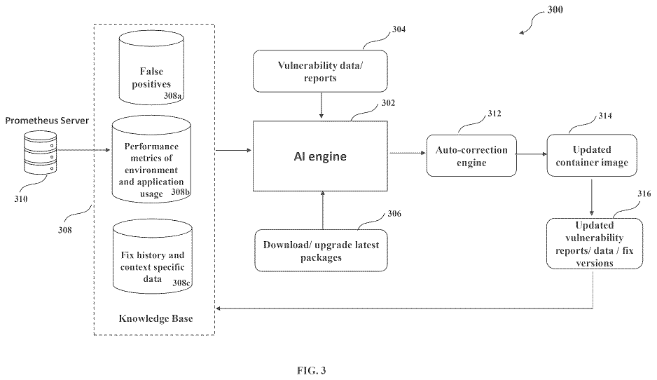

In an embodiment, the AI engine 210c is configured to analyze the vulnerability data, obtained from the vulnerability scanner 204, for each container image of the plurality of container images, wherein the vulnerability data is analyzed based on historical data stored in a knowledge base 210d. In an embodiment, the knowledge base 210d may comprise historical data including but not limited to data on context-specific vulnerabilities, past vulnerability reports, data on false positives and performance metrics of the containerized applications. The functionality of the AI engine 210c in implementing IVFRS 202 based on historical data stored in the knowledge base 210d is explained in greater detail in FIG. 3.

In an embodiment, the AI engine 210c is configured to recommend a suggested version of the software package for each container image of the plurality of container images based on the analysis of the vulnerability data. In an embodiment, the suggested version recommended by the AI engine 210c may be same as the alternate or patch version identified in the vulnerability data obtained from the vulnerability scanner 204. In an embodiment, the suggested version recommended by the AI engine 210c may be different from the alternate version identified in the vulnerability data obtained from the vulnerability scanner 204. The AI engine 210c leverages historical data to analyze and filter the vulnerability data and recommends a suitable version of the OS package for the container image.

In an embodiment, an auto-correction engine 210e of the IVFRS is configured to automatically upgrade the vulnerable version of the software package based on comparison of the alternate version of the software package identified in the vulnerability data and the suggested version of the software package recommended by the artificial intelligence engine 210c. In an embodiment, the auto-correction engine 210e automatically upgrades the vulnerable version of the OS package in the container image to the suggested version in response to determining that the suggested version recommended by the AI engine 210 is different from the alternate version identified in the vulnerability data obtained from vulnerability scanner 204. In another embodiment, the auto-correction engine 210e automatically upgrades the vulnerable version of the OS package to the alternate version in response to determining that the suggested version recommended by the AI engine 210c is same as that of the alternate version identified in the vulnerability data obtained from vulnerability scanner 204.

In an embodiment, the auto-correction engine 210e is configured to upgrade the vulnerable version of the software package in the container image by patching or fixing one or more components of the software package to generate an updated container image. In an embodiment, the remediation of the vulnerable version of the OS package may include updating the one or more software components of the OS package which may include updating the base container image, upgrading libraries, dependencies or executables and corresponding code changes in the docker file. In an embodiment, the auto-correction engine 210e is configured to automatically update or patch one or software components of the docker file to upgrade the vulnerable OS version to the correct or suggested OS version and thereby generate an updated and secure container image. In an embodiment, the IVFRS is configured to deploy the updated container image into production environment.

In an embodiment, the IVFRS 202 is configured to integrate with a continuous integration/continuous deployment (CI/CD) pipeline, 212. Typically, a CI/CD pipeline 212 is part of Devops practice that allows building, testing and deployment of container images into production environment. Examples of such CI/CD pipeline may include but not limited to Jenkins®, Appveyor® and the like. The CI/CD pipeline 212 also performs testing of the updated container image before release/deployment into production. The CI/CD pipeline 212 executes test cases 214 to validate if the updated container image or the applied fixes generated by the auto-correction engine 210e do not hamper the functionality of applications. The CI/CD pipeline 212 must be built successfully before proceeding with code changes. If the build passes or the validation of the updated container image is successful, the IVFRS is configured to automatically push the code changes or the updated container image to production.

In an embodiment, the updated container image generated by the auto-correction engine 210e may be stored in a container image repository 218. The container image repository or image registry 218 is a data repository for storage and distribution of base container images. Examples of such container image repositories may be Docker Hub, Google Container Registry among others. The container image registry 218 may be a data repository in the cloud or on-premise or on a developer's computer. If the build fails or the validation of the updated image is not successful, a pull request (PR) 216 is raised, and repository owner is informed. In an embodiment, the IVFRS 202 is configured to send an automated email 224 to the repository owner to perform manual fixing of the one or more components of the software package to remove vulnerabilities in case the validation of the updated container image fails.

In an embodiment, the IVFRS 202 is configured to re-scan 220 the updated container image for vulnerabilities. If the updated container image is free from vulnerabilities, it is stored in a production repository 222 and pushed into the production environment. In an embodiment, the IVFRS is configured to send automated emails 224 with vulnerability analysis report to one or more users. In an embodiment, the IVFRS is configured to continuously monitor the health and performance of the CI/CD pipeline 212. In an embodiment, the IVFRS 202 is configured to revert to a previous version of the software package if the deploying of the updated container image is not successful. For example, the IVFRS is configured to continuously monitor the health of the system and perform automatic rollback mechanisms to revert changes in case of deployment failures or unit test failures. Upon deployment, IVFRS is further configured to perform dynamic analysis in real-time to monitor the behavior and performance of the system to ensure that the deployed applications remain secure and stable. In an embodiment, the IVFRS 202 is configured to store the vulnerability reports and data in the knowledge base 210d for subsequent deployment. The stored vulnerability report is further leveraged by the by the AI engine 210c for analysis and for future deployments.

In one or more embodiments, the system 200 may include one or more software modules or components for managing security vulnerabilities in container images in dynamic work environments in accordance with the one or more embodiments of the present disclosure. In an embodiment, the one or more software modules may include but not limited to the AI engine 210c, auto-correction engine 210e which implements the functions of the IVFRS 202 through the processor 210a.

The functions of the AI engine 210c of IVFRS 202 is described in greater detail in FIG. 3.

FIG. 3 is an exemplary block diagram illustrating implementation of a system for securing containerized applications (of FIG. 2) using AI engine in accordance with one or more embodiments described herein. As shown in FIG. 3, the system 300 is an AI-powered vulnerability management system having an AI engine 302 configured to provide dynamic analysis of container images. In an embodiment, the AI engine 302 is configured to integrate with vulnerability scanners (204, FIG. 2) to fetch vulnerability data and reports 304 associated with a plurality of container images. Some examples of known vulnerability scanners are listed in FIG. 2 and not discussed here for the sake of brevity. The vulnerability data 304 fetched from vulnerability scanners identifies a vulnerable version of a software package and an alternate version or the patch version of the software package. For example, a container image may have an outdated or vulnerable version of the software package (i.e. operating system (OS) package) which makes the container image and the container not secure for deployment. In an embodiment, the vulnerability data is obtained from vulnerability scanner 204 using REST APIs. In an embodiment, the vulnerability data may be a vulnerability analysis report generated by scanning the container images. The report may include vulnerability details such as the severity of the security vulnerability for each container image, name of the container image, the name of the OS package, name of the container, the organization ID, the vulnerable version of the OS package, the alternate version of the OS package which is the available fix or patch for the vulnerable version, the CVE (common vulnerabilities exposure) score, CVSS score among others.

In an embodiment, the vulnerability data so obtained from the vulnerability scanners is further screened, filtered and analyzed in real-time by the AI engine 302 based on historical data stored in the knowledge base 308 to recommend a suggested version of the OS package for remediating the vulnerability. In an embodiment, the knowledge base may include data including but not limited to data on false positives 308a, data on performance metrics of containerized environment and application usage 308b, vulnerability fix history and data on context-specific vulnerabilities 308c. Some example operations performed by the AI engine 302 in analyzing the vulnerability data and the container images is explained below.

One example operation performed by the AI engine 302 may be analysis of the past vulnerability reports and outcomes to refine detection accuracy of the vulnerable versions of the OS package in the container image, ensuring that only genuine threats are flagged and suggesting the correct patch version. Another example operation performed by the AI engine 302 may be to analyze the container images to reduce false positives by leveraging historical data and source code stored in the knowledge base 308. For instance, the vulnerability data may indicate a particular version of the OS package as vulnerable. The AI engine 302, based on its analysis may flag the identified vulnerable version as a false positive by leveraging historical data. In yet another example operation, the AI engine 302 is configured to identify the prioritization and impact of the security vulnerability based on the performance metrics and application usage obtained from a Prometheus server 310. As is known, Prometheus server 310 is commonly used in orchestration platforms to store real-time metrics data relating to containerized environment. In yet another example operation, the AI engine 302 is configured to provide a precise assessment of the vulnerabilities based on the context of the containerized environment. The AI engine 302 leverages data on context-specific vulnerabilities 308c available in the knowledge base 308 to suggest fix versions of the OS package that are best suited to the environment. In an embodiment, the suggested version recommended by the AI engine 302 may be same as the alternate or patch version identified in the vulnerability data obtained from the vulnerability scanner. In an embodiment, the suggested version recommended by the AI engine 302 may be different from the alternate version identified in the vulnerability data obtained from the vulnerability scanner. In an embodiment, the alternate version identified in the vulnerability data may flagged as a false positive by the AI engine 302 during its analysis.

In an embodiment, the auto-correction engine 312 of the IVFRS is configured to automatically upgrade the vulnerable version of the software package based on comparison of the alternate version of the software package identified in the vulnerability data and the suggested version of the software package recommended by the AI engine 302. In an embodiment, the auto-correction engine 312 automatically upgrades the vulnerable version of the OS package in the container image to the suggested version in response to determining that the suggested version recommended by the AI engine 302 is different from the alternate version identified in the vulnerability data obtained from vulnerability scanner. In another embodiment, the auto-correction engine 312 automatically upgrades the vulnerable version of the OS package to the alternate version in response to determining that the suggested version recommended by the AI engine 302 is same as that of the alternate version identified in the vulnerability data obtained from vulnerability scanner. In an embodiment, the latest OS packages 306 may be available to be dynamically downloaded to fix the vulnerabilities.

In an embodiment, the auto-correction engine 312 is configured to upgrade the vulnerable version of the software package in the container image by patching or fixing one or more components of the software package to generate an updated container image 314. In an embodiment, the remediation of the vulnerable version of the OS package may include updating the one or more software components of the OS package which may include updating the base container image, upgrading libraries, dependencies or executables and corresponding code changes in the docker file. In an embodiment, the auto-correction engine 312 is configured to automatically update or patch one or software components of the docker file to upgrade the vulnerable OS version to the correct OS version and thereby generate an updated and secure container image 314. In an embodiment, the auto-correction engine 312 automatically applies patches to the base OS layers of container images This process is fully automated, eliminating the need for manual intervention. The AI engine 302 has the intelligence to decide on upgrading the specific libraries or the OS version directly. Thus, the patched images are rebuilt to incorporate the fixes, ensuring that vulnerabilities are addressed promptly.

In an embodiment, the AI engine 302 is configured to deploy the updated container image 314 into production environment. In an embodiment, the updated container image 314 generated by the auto-correction engine 312 may be stored in a container image repository. In an embodiment, automated emails with vulnerability analysis report are sent to one or more users. In an embodiment, dynamic analysis is performed in real-time to monitor the behavior and performance of the system to ensure that the deployed applications remain secure and stable. In an embodiment, the data on updated vulnerability reports and fix versions are stored in the knowledge base 308 for subsequent deployment. The stored vulnerability data is further leveraged by the by the AI engine 302 for analysis and for future deployments.

FIG. 4 is another exemplary block diagram illustrating a system 400 for securing containerized applications in accordance with one or more embodiments described herein. In an embodiment, the system 400 for securing containerized applications may be an Integrated Vulnerability Fix and Redeployment System (IVFRS), 402 and may be an on-premise deployment. Repetitive description of like elements and/or processes employed in respective embodiments is omitted for sake of brevity.

The system 400 may be implemented by one or more processors or modules illustrated and explained in FIG. 2. Similarly, the functions and operations of the vulnerability scanner 404, orchestration platform 406, processor 410a, memory 410b, AI engine 410c, auto-correction engine 410e are described in detail in FIG. 2 and are only briefly discussed in this embodiment herein.

The system 400 may be operable by a business entity 102 (FIG. 1) to fix vulnerabilities in container images. According to an embodiment, the IVFRS 402 is configured to dynamically analyze security vulnerabilities in a plurality of container images or docker images. In some embodiments, the AI engine 410c of IVFRS 402 is configured to obtain vulnerability data associated with a plurality of container images, wherein the vulnerability data identifies a vulnerable version of a software package and an alternate version of the software package. The IVFRS 402 integrates with known vulnerability scanners 404 to obtain vulnerability data identifying the vulnerable versions and the patch or alternate versions for a plurality of container images.

In an embodiment, the AI engine 410c is configured to analyze the vulnerability data, obtained from the vulnerability scanner 404, for each container image of the plurality of container images, wherein the vulnerability data is analyzed based on historical data stored in a knowledge base 410d. In an embodiment, the knowledge base 410d may comprise historical data including but not limited to data on context-specific vulnerabilities, past vulnerability reports, data on false positives and performance metrics of the containerized applications.

In an embodiment, the AI engine 410c is configured to recommend a suggested version of the software package for each container image of the plurality of container images based on the analysis of the vulnerability data. In an embodiment, the suggested version recommended by the AI engine 410c may be same as the alternate or patch version identified in the vulnerability data obtained from the vulnerability scanner 404. In an embodiment, the suggested version recommended by the AI engine 410c may be different from the alternate version identified in the vulnerability data obtained from the vulnerability scanner 404.

In an embodiment, an auto-correction engine 410e of the IVFRS is configured to automatically upgrade the vulnerable version of the software package based on comparison of the alternate version of the software package identified in the vulnerability data and the suggested version of the software package recommended by the artificial intelligence engine 410c. In an embodiment, the auto-correction engine 410e automatically upgrades the vulnerable version of the OS package in the container image to the suggested version in response to determining that the suggested version recommended by the AI engine 410c is different from the alternate version identified in the vulnerability data obtained from vulnerability scanner 404. In another embodiment, the auto-correction engine 410e automatically upgrades the vulnerable version of the OS package to the alternate version in response to determining that the suggested version recommended by the AI engine 410c is same as that of the alternate version identified in the vulnerability data obtained from vulnerability scanner 404.

In an embodiment, the auto-correction engine 410e is configured to upgrade the vulnerable version of the software package in the container image by patching of fixing one or more components of the software package to generate an updated container image. In an embodiment, the remediation of the vulnerable version of the OS package may include updating the one or more software components of the OS package which may include updating the base container image, upgrading libraries, dependencies or executables and corresponding code changes in the docker file. In an embodiment, the auto-correction engine 410e is configured to automatically update or patch one or software components of the docker file to upgrade the vulnerable OS version to the correct OS version and thereby generate an updated and secure container image. In an embodiment, the IVFRS is configured to deploy the updated container image into production environment.

In an on-premise deployment as illustrated in FIG. 4, the IVFRS 402 comprises a QA server 412 which is configured to test the quality of the updated container image. In an embodiment, the QA server 412 generates automated test scripts for automated testing and quality measurement of the updated container image before release and deployment into production. The QA server 412 validates if the updated container image or the applied fixes generated by the auto-correction engine 410e do not hamper the functionality of applications. The validation is performed before proceeding with code changes. The automated test scripts can be executed in the customer's environment to ensure compatibility and stability. If the build passes or the validation of the updated container image is successful, the IVFRS 402 is configured to automatically push the code changes or the updated container image to production.

In an embodiment, the updated container image generated by the auto-correction engine 410e may be stored in a container image repository 416. The container image repository 416 or image registry is a data repository for storage and distribution of base container images. The container image registry 416 may be a data repository in the cloud or on-premise or on a developer's computer. If the build fails or the validation of the updated image is not successful, a pull request (PR) 414 is raised, and repository owner is informed. In an embodiment, the IVFRS 402 is configured to send an automated email 422 to the repository owner to perform manual fixing of the one or more components of the software package to remove vulnerabilities.

In an embodiment, the IVFRS 402 is configured to re-scan 418 the updated container image for vulnerabilities. If the updated container image is free from vulnerabilities, it is stored in a production repository 420 and pushed into the production environment. In an embodiment, the IVFRS is configured to send automated emails 422 with vulnerability analysis report to one or more users. In an embodiment, the IVFRS 402 is configured to continuously monitor the health and performance of system. In an embodiment, the IVFRS 402 is configured to revert to a previous version of the software package if the deploying of the updated container image is not successful. For example, the IVFRS is configured to continuously monitor the health of the system and perform automatic rollback mechanisms to revert changes in case of deployment failures or unit test failures. Upon deployment, IVFRS is further configured to perform dynamic analysis in real-time to monitor the behavior and performance of the system to ensure that the deployed applications remain secure and stable. In an embodiment, the IVFRS 402 is configured to store the vulnerability report in the knowledge base 410d for subsequent deployment. The stored vulnerability report is further leveraged by the by the AI engine 410c for analysis and for future deployments.

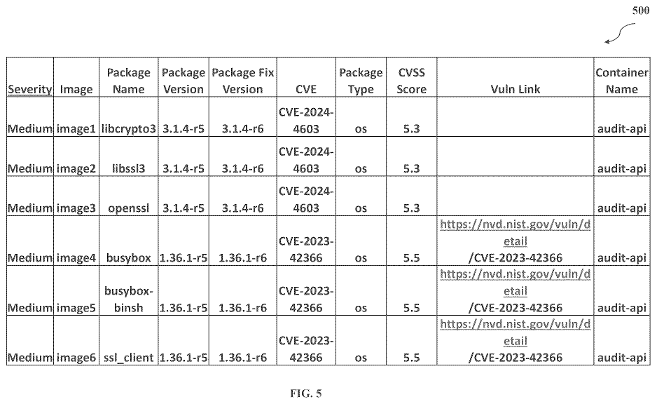

FIG. 5 is an exemplary vulnerability report generated before vulnerability remediation in accordance with one or more embodiments described herein. In an embodiment, the Integrated Vulnerability Fix and Redeployment System, IVFRS 202, 402 as illustrated in FIGS. 2 and 4 is configured to integrate with known vulnerability scanners to obtain vulnerability data. The exemplary vulnerability data as shown in FIG. 5 includes few example details on vulnerability. The vulnerability report may also include other details not shown in the report including but not limited to details such as the name of the cluster, the organization ID, among others.

As shown in FIG. 5, the exemplary vulnerability report includes data on severity of the security vulnerability associated a plurality of container images. For instance, the severity or threat level of vulnerability of the container image can be classified as low, medium and high. In an embodiment, if the severity of the vulnerability is low, the container image may have lesser processing priority compared to the container image classified as having a high severity. Example container images in FIG. 5 are listed as image 1, image 2, image 3 etc. The vulnerability report further includes the name of the OS package, the vulnerable version of the OS package (indicated as package version in FIG. 5) and the alternate version of the OS package (indicated as package fix version in FIG. 5). Some non-limiting examples of OS packages shown in FIG. 5 include libcrypto3, openssl, busybox, etc. The vulnerability report further includes standard vulnerability scores obtained using common vulnerability scoring system (CVSS score), common vulnerabilities and exposures (CVE) code and a vulnerability link for each container image. The higher the CVSS score, the higher the severity of the vulnerability.

In an example of the vulnerability data shown in FIG. 5, version “3.1.4-r5” of the OS package “libcrypto3” in container image “image 1” is identified to be a vulnerable version and the alternate version or the available fix version is identified to be “3.1.4-r6”. The severity of the vulnerability for the OS package “libcrypto3” is classified as medium and corresponding CVSS score and CVE code are indicated in the report. Similar examples of vulnerable versions of the OS package and the available patch or fix versions are identified for container images, “image 1, “image2”, “image3”, “image4”, etc. FIG. 5 is an example of a traditional vulnerability report generated by vulnerability scanners which indicates the vulnerable version and the patch version for remediating the vulnerability.

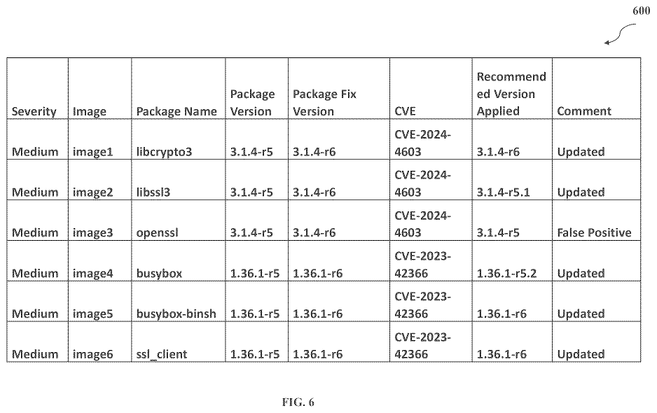

In an embodiment, the vulnerability data of FIG. 5 is analyzed by the IVFRS to remediate the vulnerability and generate updated data on vulnerability and fix versions which is illustrated in FIG. 6

FIG. 6 is an exemplary vulnerability report generated after vulnerability remediation by the system of FIGS. 1-3, in accordance with one or more embodiments described herein. In an embodiment, the exemplary vulnerability data of FIG. 5 generated by the vulnerability scanners is fed into the AI engine 210c, 302, 410c of FIGS. 2,3,4. In an example operation, the AI engine analyses the vulnerability data of container image “image1”, where version “3.1.4-r5” of the OS package “libcrypto3” in container image “image 1” is identified to be a vulnerable version and the alternate version or the available fix version is identified to be “3.1.4-r6”. In analyzing “image1”, the AI engine leverages the historical data available in the knowledge base to determine and recommend the suitable OS version for vulnerability remediation. As shown in FIG. 6, the recommended version (indicated as recommended version applied in FIG. 6) that is applied to the OS package is “3.1.4-r6”, which is same as that of the alternate version. In another example operation, the AI engine analyzes “image2” for which the vulnerable version of the OS package “libssl3” is identified to be “3.1.4-r5” and the patch version is identified to be “3.1.4-r6” by the vulnerability scanner. Upon analysis, the AI engine recommends a different version of the OS package “3.1.4-r5.1” based on the historical data including context-specific vulnerability, past vulnerability reports and fix history and performance metrics of the containerized environment. As shown in FIG. 6, the recommended fix version applied for “image2” is “3.1.4-r5.1” and not “3.1.4-r5”. In yet another example operation, the AI engine analyzes “image3”, for which the vulnerable version of the OS package “openssl” is identified to be version “3.1.4-r5” and the fix version to be “3.1.4-r6”. The AI engine upon analysis suggests that the version “3.1.4-r5” identified to be vulnerable is a false positive. FIG. 6 shows also shows other examples where recommended versions have been applied for “image4”, “image5”, “image6”, wherein recommended version is different from package fix version for “image4”, and recommended version is same as that of package fix version for “image5” and “image6”. Thus, the versions of the OS package recommended by the AI engine may be same as that of the alternate version and different from the alternate version in certain embodiments. In certain other embodiments, the AI engine detects the identified vulnerable version to be a false positive. Upon identifying the correct OS version, upgrades to the OS package is performed by automatically patching one or more software components of the docker file to generate and build an updated container image for storage and deployment.

Thus, according to the exemplary embodiments of the present disclosure, the vulnerability data generated by the vulnerability scanner is integrated and fed into the artificial intelligence platform of IVFRS to filter and improve the detection accuracy of the vulnerable versions and to recommend OS versions that are suitable for remediating the vulnerability. The IVFRS of the present disclosure has the intelligence to refine detection accuracy of the vulnerable OS versions by flagging only genuine threats, recommend suitable OS versions for remediating the vulnerability and automatically patch the vulnerable versions to upgrade to the recommended version. This real-time analysis and automated patching process by IVFRS enable deployment quick and free from security vulnerabilities.

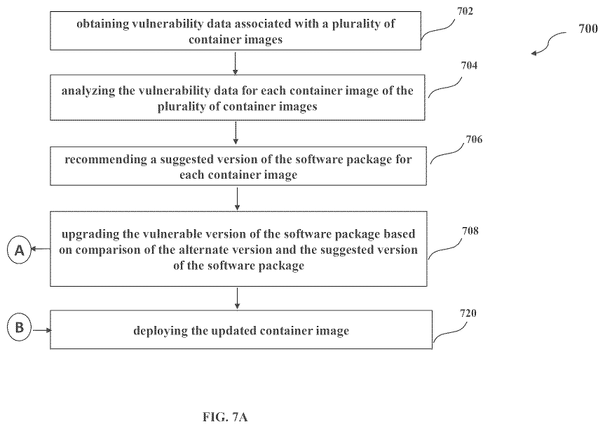

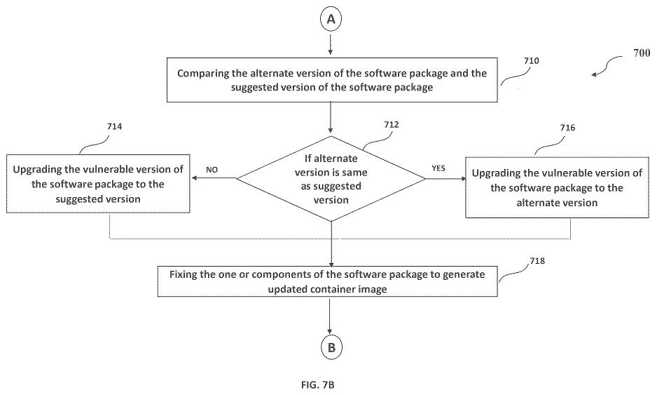

FIGS. 7A and 7B illustrate exemplary flow diagrams of a method for securing containerized applications in accordance with one or more embodiments described herein. The method, 700 may be implemented by the system as described above in FIGS. 1-4. The method 700 is illustrated as logical flow diagram, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. The order in which the operations are described is not intended to be construed as a limitation, and any number of the described operations can be combined in any order and/or in parallel to implement the method.

According to an embodiment, the method 700 may be implemented by one or more processors or modules illustrated and explained through FIGS. 1-4, 8 therefore detailed explanation of the same is omitted here for the sake of brevity.

The method begins at step 702, wherein the method 700 includes obtaining vulnerability data associated with a plurality of container images, wherein the vulnerability data identifies a vulnerable version of a software package and an alternate version of the software package, from the vulnerability scanner 204 (FIG. 2). For example, a container image may have an outdated or vulnerable version of the software package (i.e. operating system (OS) package) which makes the container image and the container runtime not secure for deployment. In an embodiment, the vulnerability data is obtained from vulnerability scanner using REST APIs. The vulnerability data fetched by the vulnerability scanner identifies the vulnerable version of the OS package and the alternate version, which may be the available fix version for the OS package. In an embodiment, the vulnerability data may be a vulnerability analysis report generated by scanning the container images. The report may include vulnerability details such as the severity of the security vulnerability for each container image, name of the container image, the name of the OS package, the vulnerable version of the OS package, the alternate version of the OS package which is the available fix or patch for the vulnerable version, the CVE (common vulnerabilities exposure) score, CVSS score among others.

At 704, the method 700 includes analyzing the vulnerability data for each container image of the plurality of container images. In an embodiment, the operations at step 704 may be performed by the AI engine 210c, 302, 410c illustrated in FIGS. 2, 3,4. At step 704, the vulnerability data is analyzed based on historical data stored in a knowledge base. The knowledge base may include data including but not limited to data on false positives, data on performance metrics of containerized environment and application usage, vulnerability fix history and data on context-specific vulnerabilities. In an embodiment, one example operation that is performed in analyzing the vulnerability data includes analyzing the past vulnerability reports and outcomes to refine detection accuracy of the vulnerable versions of the OS package in the container image, ensuring that only genuine threats are flagged and suggesting the correct patch version. Another example operation may include analyzing the container images to reduce false positives by leveraging historical data and source code stored in the knowledge base. In yet another example operation, analyzing the vulnerability data at step 704 may include identifying the priority, severity and impact of the security vulnerability based on the performance metrics and application usage. In yet another example operation, analyzing the vulnerability data includes precise assessment of the vulnerabilities based on the context of the containerized environment. This is enabled by leveraging data on context-specific vulnerabilities stored in the knowledge base to suggest fix versions of the OS package that are best suited to the environment.

At 706, the method 700 includes recommending a suggested version of the software package for each container image of the plurality of container images based on the analysis of the vulnerability data. In an embodiment, the operations at step 706 may be performed by the AI engine 210c, 302, 410c illustrated in FIGS. 2, 3,4. At step 706, a suggested version of the OS package for the container image is recommended for fixing the vulnerable version based on analysis of the vulnerability data. In an embodiment, the suggested version recommended by the AI engine may be same as the alternate or patch version identified in the vulnerability data obtained from the vulnerability scanner. In an embodiment, the suggested version recommended by the AI engine may be different from the alternate version identified in the vulnerability data obtained from the vulnerability scanner. In an embodiment, the alternate version identified in the vulnerability data may flagged as a false positive by the AI engine during its analysis.

At 708, the method 700 includes automatically upgrading the vulnerable version of the software package in the container image based on comparison of the alternate version of the software package identified in the vulnerability data and the suggested version of the software package recommended by the artificial intelligence engine. In an embodiment, the operations at step 708 may be performed by the auto-correction engine 210e, 312, 410e illustrated in FIGS. 2, 3,4.

At step 710, the method 700 comprises comparing the alternate version of the software package identified in the vulnerability data with the suggested version recommended by the AI engine.

At step 712, the method 700 comprises determining if the alternate version of the software package identified in the vulnerability data is same as suggested version of the software package recommended by the AI engine.

At step 714, the method 700 further comprises automatically upgrading the vulnerable version of the software package or the OS package in the container image to the suggested version in response to determining that the suggested version recommended by the AI engine is different from the alternate version identified in the vulnerability data.

At step 716, the method 700 further comprises automatically upgrading the vulnerable version of the OS package to the alternate version in response to determining that the suggested version recommended by the AI engine is same as that of the alternate version identified in the vulnerability data.

At step 718, the method 700 further comprises upgrading the vulnerable version of the software package in the container image by patching or fixing one or more components of the software package to generate an updated container image. In an embodiment, the remediation of the vulnerable version of the OS package may include updating the one or more software components of the OS package which may include updating the base container image, upgrading libraries, dependencies or executables and corresponding code changes in the docker file. In an embodiment, the method comprises automatically updating or patching one or software components of the docker file to upgrade the vulnerable OS version to the correct OS version and thereby generating an updated and secure container image. In an embodiment, patches to the base OS layers of container images are automatically applied and this process is fully automated, eliminating the need for manual intervention. This AI engine has the intelligence to decide on upgrading the specific libraries or the OS version directly. Thus, the patched images are rebuilt to incorporate the fixes, ensuring that vulnerabilities are addressed promptly

At step 720, the method further comprises deploying the updated container image into production environment.

In an embodiment, the method comprises integrating with a continuous integration/ continuous deployment (CI/CD) pipeline in a cloud deployment. The method further comprises testing the updated container image before release and deployment into production. The method comprises executing test cases to validate if the updated container image does not hamper the functionality of applications. If the build passes or the validation of the updated container image is successful, the method comprises automatically pushing the code changes or the updated container image to production. In an on-premise deployment, the method comprises generating automated test scripts by the QA server to validate the quality of the updated container image or applied fixes before deployment.

In an embodiment, the method comprises storing the updated container image in a container image repository. The container image registry may be a data repository in the cloud or on-premise or on a developer's computer. If the build fails or the validation of the updated image is not successful, the method comprises raising a pull request (PR) and informing repository owner of the vulnerable container image. In an embodiment, the method comprises sending an automated email to the repository owner to perform manual fixing of the one or more components of the software package to remove vulnerabilities.

In an embodiment, the method comprises re-scanning the updated container image for vulnerabilities. If the updated container image is free from vulnerabilities, storing the updated container image in a production repository and pushing the image into the production environment. In an embodiment, the method comprises sending automated emails with vulnerability analysis report to one or more users. The method further comprises reverting to a previous version of the software package if the deploying of the updated container image is not successful. The method further comprises continuously monitoring the health and performance of the CI/CD pipeline. Upon deployment, the method comprises performing dynamic analysis in real-time to monitor the behavior and performance of the system to ensure that the deployed applications remain secure and stable. In an embodiment, the method comprises storing the updated vulnerability report and fix history in the knowledge base for subsequent deployment. The stored vulnerability report is further leveraged for analysis by the by the AI engine for future deployments.

FIG. 8 illustrates a general block diagram of an exemplary computing system used in the Integrated Vulnerability Fix and Redeployment system, IVFRS according to an embodiment of the present disclosure. The computing system 800 includes a processor 801 which may be a single processing unit or a number of units, all of which could include multiple computing units. The processor 801 may be implemented as one or more microprocessors, microcomputers, microcontrollers, digital signal processors, central processing units, logical processors, virtual processors, state machines, logic circuitries, and/or any devices that manipulate signals based on operational instructions. Among other capabilities, the processor 801 is configured to fetch and execute computer-readable instructions and data stored in a memory 802.

The memory 802 may be any non-transitory computer-readable medium known in the art including, for example, volatile memory, such as static random-access memory (SRAM) and dynamic random-access memory (DRAM), and/or non-volatile memory, such as read-only memory (ROM), erasable programmable ROM, flash memories, hard disks, optical disks, and magnetic tapes.

In an example, the computing system 800 may include one or more software modules or components 804 for securing containerized applications in accordance with the one or more embodiments of the present disclosure. In an embodiment, the one or more software modules 804 may include a program, a subroutine, a portion of a program, a software component or a hardware component capable of performing a stated task or function. As used herein, the modules may be implemented on a hardware component such as a server independently of other modules, or a module can exist with other modules on the same server, or within the same program. The module(s) 804 may be implemented on a hardware component such as processor one or more microprocessors, microcomputers, microcontrollers, digital signal processors, central processing units, state machines, logic circuitries, and/or any devices that manipulate signals based on operational instructions. The module(s) 804 when executed by the processor 801 may be configured to perform any of the described functionalities. Specifically, the module(s) 804 may be configured to implement the Integrated Vulnerability Fix and Redeployment System enabling automated vulnerability management.

The computing system 800 may comprise a database 803 and may be implemented with integrated hardware and software. The hardware may include a hardware disk controller with programmable search capabilities or a software system running on general-purpose hardware. Examples of databases are but not limited to, in-memory databases, cloud databases, distributed databases, embedded databases, and the like. The database amongst other things, serves as a repository for storing data processed, received, and generated by one or more of the processors 801, and the module(s) 804. In an embodiment, the modules 804 may be implemented with an AI/ML module.

The computing system 800 comprises a display unit 805 that includes a computer monitor, a touch screen, an output device capable of displaying the graphics, and the like. The display unit 805 is configured to display visual output in desktops, laptops, and workstations.

The computing system 800 comprises a network interface 806 configured to provide and establish communication with any electronic device via a public network, private network, or any wireless communication technology.

Embodiments of the present disclosure may thus provide an efficient and automated system and method for managing security vulnerabilities involving containerized applications in dynamic business environments. The system is aimed to provide optimum performance and is adaptable to evolving business requirements, making it easy for the users to effectively resolve security issues and problem scenarios and quickly deploy applications. The disclosed techniques aids in improving the overall health of the system by reducing costs, optimizing resources, reducing time spent on manual processes, thereby providing enhanced system performance.

Embodiments of the present disclosure enable dynamically managing security vulnerabilities in the work environments, resulting in improved operational efficiency of the business processes and system performance. The disclosed system and method provide AI-powered vulnerability management with unique capabilities that performs static and dynamic analysis, significantly reducing false positives and ensuring accurate security threat detection. This makes IVFRS an invaluable tool for organizations looking to enhance their DevOps security posture, ensuring a secure and efficient application deployment process.

The disclosed system and method may leverage Artificial intelligence (AI) models to implement the various functionalities disclosed herein. The AI models may be utilized to observe and track container pipelines in real-time by providing automated vulnerability management techniques thereby avoiding downtime and ensuring accurate, consistent and timely deployment and delivery of applications and data.

The figures of the disclosure are provided to illustrate some examples of the invention described. The figures are not to limit the scope of the depicted embodiments or the appended claims. Aspects of the disclosure are described herein with reference to the invention to example embodiments for illustration. It should be understood that specific details, relationships, and method are set forth to provide a full understanding of the example embodiments. One of ordinary skill in the art recognize the example embodiments can be practiced without one or more specific details and/or with other methods.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

The phrases “in one embodiment,” “according to one embodiment,” and/or the like generally mean that the particular feature, structure, or characteristic following the phrase may be included in at least one embodiment of the present disclosure and may be included in more than one embodiment of the present disclosure (importantly, such phrases do not necessarily refer to the same embodiment). The present disclosure intends to include specific reference to all combinations and sub combinations of physically compatible features, components, apparatuses, and processes described herein. As used herein, the term “or” is used in both the alternative and conjunctive sense, unless otherwise indicated. Use of any such aforementioned terms, or similarly interchangeable terms, should not be taken to limit the spirit and scope of embodiments of the present disclosure. As used in the specification and the appended claims. The singular form of “a,” “an,” and “the” include plural references unless otherwise stated. The terms “includes” and/or “including,” when used in the specification, specify the presence of stated features, elements, and/or components, and/or groups thereof.

In an embodiment, the functional units have been labeled as modules, in order to more particularly emphasize their implementation independence. For example, a module may be implemented as a hardware or a software by various types of processors. A module of executable code may, for instance, comprise one or more physical or logical blocks of computer instructions, which may, for instance, be organized as an object, procedure, or function. Nevertheless, the executables of a module need not be physically located together, but may comprise disparate instructions stored in different locations which, when joined logically together, comprise the module and achieve the stated purpose for the module.

Aspects of the present disclosure may be implemented as computer program products that comprise articles of manufacture. Such computer program products may include one or more software components including, for example, applications, software objects, methods, data structure, and/or the like. In some embodiments, a software component may be stored on one or more non-transitory computer-readable media, which computer program product may comprise the computer-readable media with software component, comprising computer executable instructions, included thereon. The various control and operational systems described herein may incorporate one or more of such computer program products and/or software components for causing the various conveyors and components thereof to operate in accordance with the functionalities described herein.

A software component may be coded in any of a variety of programming languages. An illustrative programming language may be a lower-level programming language such as an assembly language associated with a particular hardware architecture and/or operating system platform/system. Other example of programming languages included, but are not limited to, a macro language, a shell or command language, a job control language, a script language, a database query, or search language, and/or report writing language. In one or more example embodiments, a software component comprising instructions in one of the foregoing examples of programming languages may be executed directly by an operating system or other software component without having to be first transformed into another form. A software component may be stored as a file or other data storage methods. Software components of a similar type or functionally related may be stored together such as, for example, in a particular directory, folder, or repository. Software components may be static (e.g., pre-established, or fixed) or dynamic (e.g., created or modified at the time of execution).

Processor may be embodied in a number of different ways. In various embodiments, the use of the terms “processor” should be understood to include a single core processor, a multi-core processor, multiple processors and/or one or more remote or “cloud” processor(s). In some example embodiments, processor may include one or more processing devices configured to perform independently. In some embodiments, the processor includes hardware, software, firmware, and/or a combination thereof that performs one or more operations described herein.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

In some embodiments, a storage system or other management entity within the artificial intelligence and machine learning infrastructure may also implement automated training with continuous learning based on new data.

It is to be understood that the disclosure is not to be limited to the specific embodiments disclosed, and that modifications and other embodiments are intended to be included within the scope of the appended claims. Although specific terms are employed herein, they are used in a generic and descriptive sense only and not for purposes of limitation, unless described otherwise.

What is claimed:

1. A method for securing containerized applications comprising:
obtaining vulnerability data associated with a plurality of container images, wherein the vulnerability data identifies a vulnerable version of a software package and an alternate version of the software package;
analyzing, by an artificial intelligence engine, the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base;
recommending, by the artificial intelligence engine, a suggested version of the software package for each container image;
upgrading the vulnerable version of the software package based on comparison of the alternate version of the software package and the suggested version of the software package,
wherein upgrading the vulnerable version of the software package comprises fixing one or more components of the software package to generate an updated container image; and
deploying the updated container image.

2. The method of claim 1, wherein the alternate version is different from the suggested version.

3. The method of claim 1, wherein the alternate version is same as the suggested version.

4. The method of claim 1, further comprising integrating the updated container image into a continuous integration/continuous deployment (CI/CD) pipeline.

5. The method of claim 1, further comprising validating the updated container image using automated test scripts.

6. The method of claim 5, further comprising sending an email to a repository owner to perform manual fixing of the one or more components of the software package if the validating of the updated container image is not successful.

7. The method of claim 1, further comprising re-scanning the updated container image for vulnerability.

8. The method of claim 1, further comprising storing the updated container image in a repository.

9. The method of claim 1, further comprising sending automated emails to one or more users with vulnerability report.

10. The method of claim 1, further comprising reverting to a previous version of the software package if the deploying of the updated container image is not successful.

11. The method of claim 1, further comprising monitoring performance of the containerized applications in real-time

12. The method of claim 1, further comprising storing the vulnerability report in the knowledge base for subsequent deployment.

13. A system for securing containerized applications comprising:
a processor; and
a memory storing program instructions which, when executed by the processor, causes the processor to:
obtain vulnerability data associated with a plurality of container images, wherein the vulnerability data identifies a vulnerable version of a software package and an alternate version of the software package;
analyze, by an artificial intelligence engine, the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base;
recommend, by the artificial intelligence engine, a suggested version of the software package for each container image;
upgrade the vulnerable version of the software package based on comparison of the alternate version of the software package and the suggested version of the software package,
wherein the processor is configured to upgrade the vulnerable version of the software package by fixing one or more components of the software package to generate an updated container image; and
deploy the updated container image.

14. The system of claim 13, wherein the alternate version is different from the suggested version.

15. The system of claim 13, wherein the alternate version is same as the suggested version.

16. The system of claim 13, wherein the processor is configured to integrate the updated container image into a continuous integration/continuous deployment (CI/CD) pipeline.

17. The system of claim 13, wherein the processor is configured to validate the updated container image using automated test scripts.

18. The system of claim 13, wherein the processor is configured to store the updated container image in a repository.

19. The system of claim 13, wherein the processor is configured to re-scan the updated container image for vulnerability.

20. A non-transitory computer-readable storage medium, storing program instructions for securing containerized applications, the program instructions, when executed, perform the steps of:
obtaining vulnerability data associated with a plurality of container images, wherein the vulnerability data identifies a vulnerable version of a software package and an alternate version of the software package;
analyzing, by an artificial intelligence engine, the vulnerability data for each container image of the plurality of container images, wherein the vulnerability data is analyzed based on historical data including at least one of context-specific vulnerabilities, past vulnerability reports, false positives and performance metrics of the containerized applications, stored in a knowledge base;
recommending, by the artificial intelligence engine, a suggested version of the software package for each container image;
upgrading the vulnerable version of the software package based on comparison of the alternate version of the software package and the suggested version of the software package,
wherein upgrading the vulnerable version of the software package comprises fixing one or more components of the software package to generate an updated container image; and
deploying the updated container image.
